(19) United States
(12) Patent Application Publication
(10) Pub. No.: US 2022/0371168 A1
(43) Pub. Date: Nov. 24, 2022

(54) AIR-PATH STRUCTURE OF PNEUMATIC NAIL GUN

(71) Applicant: DE POAN PNEUMATIC CORP., NEW TAIPEI CITY (TW)

(72) Inventors: I-TSUNG WU, NEW TAIPEI CITY (TW); CHIA-SHENG LIANG, NEW TAIPEI CITY (TW); ZHEN-LIANG LIAO, NEW TAIPEI CITY (TW)

(21) Appl. No.: 17/724,032

(22) Filed: Apr. 19, 2022

(30) Foreign Application Priority Data
May 18, 2021 (TW) 110117906

(51) Int. Cl. B25C 1/04

(52) U.S. Cl. CPC B25C 1/047; B25C 1/046; B25C 1/045

(57) ABSTRACT

An air-path structure of pneumatic a nail gun, formed inside a gun body containing high-pressure air, comprises a main air chamber, a firing valve air chamber and a time-delayed air chamber that continuously releases the high-pressure air to the atmosphere. The gun body is configured with a trigger valve and a slider valve. The inside of the trigger valve is formed with a safety-on air chamber and a safety-off air chamber. The trigger valve controls the high-pressure air inside the firing valve air chamber to be discharged to the atmosphere. The slider valve controls the high-pressure air inside the main air chamber flowing toward the firing valve air chamber, the time-delayed air chamber and the safety-off air chamber. Specifically, the safety-on air chamber is constantly communicated with the main air chamber and constantly contains high-pressure air, and the slider valve can control the high-pressure air inside the safety-off air chamber flowing into the time-delayed air chamber. In this way, the invention can improve the operating safety of conventional pneumatic nail guns.

### BACKGROUND OF INVENTION

### 1. Field of the Invention

The present invention relates generally to the structural configuration of a pneumatic nail gun, and more particularly to the air-path structure of a pneumatic nail gun.

### Prior Art

A pneumatic nail gun is a hand-held pneumatic tool powered by high-pressure air, which drives the piston to move downward to shoot the nail and to move upward to reset. Generally, according to the safety nailing operation sequence, the operation can be divided into sequential actuation mode and contact actuation mode. Specifically:

Sequential actuation mode means the user must firstly contact the safety slider with the workpiece to be nailed before pressing the trigger to actuate the trigger valve for nailing. In this mode, when another nailing is needed, the user must firstly release the trigger and then press the trigger again for a second shot. If the user does not follow the above operating sequence, i.e., if the user firstly presses the trigger and then pushes the safety slider, the trigger valve will not be actuated, and the pneumatic nail gun will not shoot the nail. Therefore, the sequential actuation mode can guarantee safety when the user operates the pneumatic nail gun.

The contact actuation mode means the user firstly presses and holds the trigger, and then directs the safety slider toward positions of the workpiece to be nailed for continuous contact knocking, thus actuating the trigger valve once after another for continuous nailing operations. In this mode, the user can also firstly push the safety slider against the workpiece to be nailed, and then press the trigger once or continuously to shoot one nail or multiple nails into the workpiece. Therefore, although the contact actuation mode provides users with the convenience of continuously shooting multiple nails when operating the pneumatic nail gun, it is more likely to cause the danger of mistaken nailing comparing to the sequential actuation mode.

As we know, to allow users to conveniently shift between the above two nailing modes, most pneumatic nail guns are configured with a valve stem for manual shifting, so that users can change the nailing mode as needed. However, the shifting device may increase the complexity of the structure and air-path of the pneumatic nail gun, and manual shifting through the valve stem is not in line with current safety guidelines for operating pneumatic nail guns.

Specifically, current safety guidelines for operating pneumatic nail guns require that the operation of pneumatic nail guns must be started from the sequential actuation mode, i.e., the user must firstly push the safety slider against the workpiece to be nailed before pressing the trigger to actuate a single shot, and the time to start the contact actuation nailing mode is further standardized through the action of the safety slider, thus enhancing the safety of operating the pneumatic nail gun. However, the manufacturing technique in this field is still immature.

### SUMMARY OF THE INVENTION

The object of the present invention is to enhance the safety of operating pneumatic nail guns. Specifically, while meeting the requirement of newest safety guidelines for operating pneumatic nail guns, the invention omits the need of the conventional valve stem for manual shifting between the two operating modes, i.e., the sequential actuation mode and the contact actuation mode. The present invention creatively uses the sliding action of the safety slider to control the initial actuation, and the nailing mode shifting can be operated safely in a habitual operating manner. In addition, the present invention also incorporates a safety function that the pneumatic nail gun can automatically recover to the preset nailing mode if there is no operation within a specific period of time, thus further enhancing the safety of operation.

In view of this, the present invention provides an air-path structure of pneumatic nail gun, comprising: a gun body, with its inside having a main air chamber containing high-pressure air, a firing valve air chamber, and a time-delayed air chamber that continuously releases the high-pressure air into the atmosphere; a trigger valve, configured on the gun body, the trigger valve comprises a shuttle valve ring, a safety-on air chamber, and a safety-off air chamber. Both ends of the shuttle valve ring are respectively exposed inside the safety-on air chamber and the safety-off air chamber. The high-pressure air inside the safety-on air chamber forms a first thrust. The high-pressure air inside the safety-off air chamber forms a second thrust. The first thrust and the second thrust respectively act on the shuttle valve ring. The second thrust is opposite the first thrust in direction. Through the shuttle valve ring, the trigger valve controls the high-pressure air inside the firing valve air chamber to be discharged out of the gun body; a slider valve, configured on the gun body, the slider valve controls the high-pressure air inside the main air chamber flowing toward the firing valve air chamber, the time-delayed air chamber and the safety-off air chamber, and controls the high-pressure air inside the safety-on air chamber and the safety-off air chamber respectively flowing toward the time-delayed air chamber; Specifically, the safety-on air chamber is constantly communicated with the main air chamber and constantly contains high-pressure air, and the high-pressure air inside the safety-off air chamber flows through the slider valve toward the time-delayed air chamber and is continuously discharged into the atmosphere, so that the first thrust is stronger than the second thrust, thus driving the shuttle valve ring to move to a safety-on position, and consequently the trigger valve will close the air flow path for the high-pressure air inside the firing valve air chamber to be discharged out of the gun body; the high-pressure air inside the main air chamber flows through the slider valve toward the safety-off air chamber, and the high-pressure air inside the safety-on air chamber flows through the slider valve toward the time-delayed air chamber and is continuously discharged into the atmosphere, so that the second thrust is stronger than the first thrust, thus driving the shuttle valve ring to move from the safety-on position to the safety-off position, and consequently the trigger valve will open the air flow path for the high-pressure air inside the firing valve air chamber to be discharged out of the gun body.

Further, the inside of the gun body is formed with an inlet flow channel, the two ends of the inlet flow channel respectively extend to the main air chamber and the safety-on air chamber, the high-pressure air inside the main air chamber flows through the inlet flow channel toward the safety-on air chamber.

Further, the trigger valve further comprises a trigger valve seat and a trigger valve stem. The trigger valve seat is located on the bottom of the trigger valve, and is fixed on the gun body. The trigger valve stem goes through the shuttle valve ring and the trigger valve seat. The safety-on air chamber is formed within the shuttle valve ring and the trigger valve seat.

The safety-off air chamber is formed between the gun body and the shuttle valve ring. Further, the shuttle valve ring has a first end face and a second end face. The first end face is exposed inside the safety-on air chamber. The second end face is exposed inside the safety-off air chamber. The area of the first end face receiving the thrust of the high-pressure air is relatively smaller than that of the second end face.

Further, between the shuttle valve ring and the trigger valve stem, a first valve portion of the trigger valve and a second valve portion of the trigger valve are formed. The ring wall of the shuttle valve ring is formed with a first perforation communicated with the slider valve, a second perforation communicated with the atmosphere, a third perforation communicated with the slider valve, and a fourth perforation communicated with the slider valve. The first valve portion of the trigger valve can control the time of communication between the first perforation and the second perforation. The second valve portion of the trigger valve can control the time of communication between the third perforation and the fourth perforation.

Further, the first valve portion of the trigger valve and the second valve portion of the trigger valve are respectively formed between the shuttle valve ring and the trigger valve stem sequentially along the axial direction of the shuttle valve ring. The first perforation, the second perforation, the third perforation, and the fourth perforation are respectively formed on the ring wall of the shuttle valve ring sequentially along the axial direction of the shuttle valve ring.

Further, the inside of the gun body is formed with a slider valve chamber. The slider valve comprises a safety slider slidably fitted inside the slider valve chamber. One end of the safety slider is extended out of the gun body, and the other end of the safety slider is planted into the main air chamber.

Further, between the slider valve chamber and the safety slider, a first valve portion of the slider valve and a second valve portion of the slider valve are respectively formed. The wall of the slider valve chamber is formed with a first flow channel communicated with the firing valve air chamber, a second flow channel communicated with the trigger valve, a third flow channel communicated with the time-delayed air chamber, a fourth flow channel communicated with the trigger valve, and a fifth flow channel communicated with the main air chamber. The first valve portion of the slider valve can control the time of communication between the main air chamber and the first flow channel, and control the time of communication between the second flow channel, the third flow channel and the fourth flow channel. The first valve portion of the slider valve can also control the time of communication between the first flow channel and the second flow channel. The second valve portion of the slider valve can control the time of communication between the third flow channel, the fourth flow channel, and the fifth flow channel.

Further, the first valve portion of the slider valve and the second valve portion of the slider valve are respectively formed between the slider valve chamber and the safety slider sequentially along the axial direction of the slider valve chamber. The first flow channel, the second flow channel, the third flow channel, the fourth flow channel, and the fifth flow channel are respectively formed on the wall of the slider valve chamber sequentially along the axial direction of the slider valve chamber.

Further, the gun body is configured with a relief valve communicated with the time-delayed air chamber. The high-pressure air inside the time-delayed air chamber is continuously discharged into the atmosphere via the relief valve.

Based on the above descriptions, the technical performance of the present invention is that: either when the pneumatic nail gun is used for the first time or when the safety slider is not pressed within a specific period of time, the user must firstly push the safety slider to start the nailing operation. Thus the safety of using the pneumatic nail gun is enhanced. In addition, the device for shifting between the two operating modes of sequential mode and contact mode can be omitted, thus reducing the structural complexity of the pneumatic nail gun.

The features and technical effects of the embodiments disclosed here are detailed below with reference to the accompanying figures.

### BRIEF DESCRIPTION OF THE DRAWINGS

FIG. 1 is a sectional view of a pneumatic nail gun according to the present invention.

FIG. 2 is a configuration view of the air-path structure of pneumatic nail gun according to the present invention.

FIG. 2a and FIG. 2b are respectively partial enlarged views of FIG. 2.

FIG. 3 to FIG. 11 are sequentially the continuous actuation illustrative views when the pneumatic nail gun is in sequential actuation mode.

FIG. 12 to FIG. 20 are sequentially the continuous actuation illustrative views when the pneumatic nail gun is in contact actuation mode.

### IMPLEMENTATION

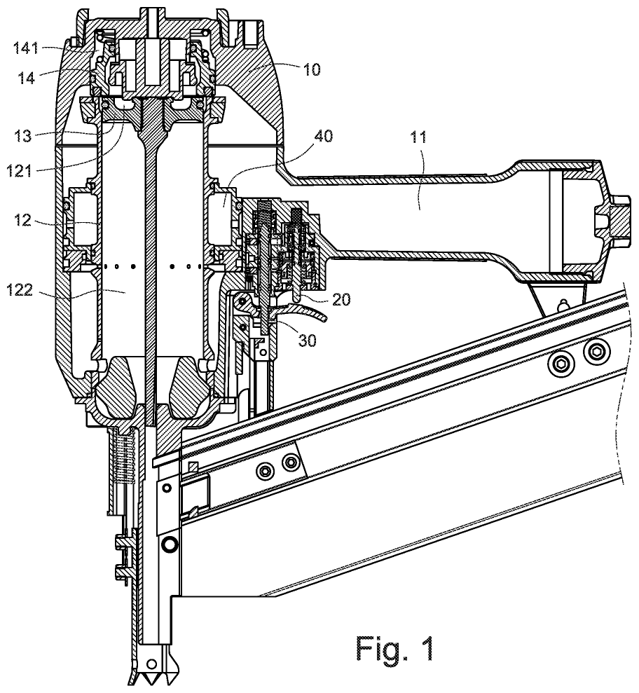

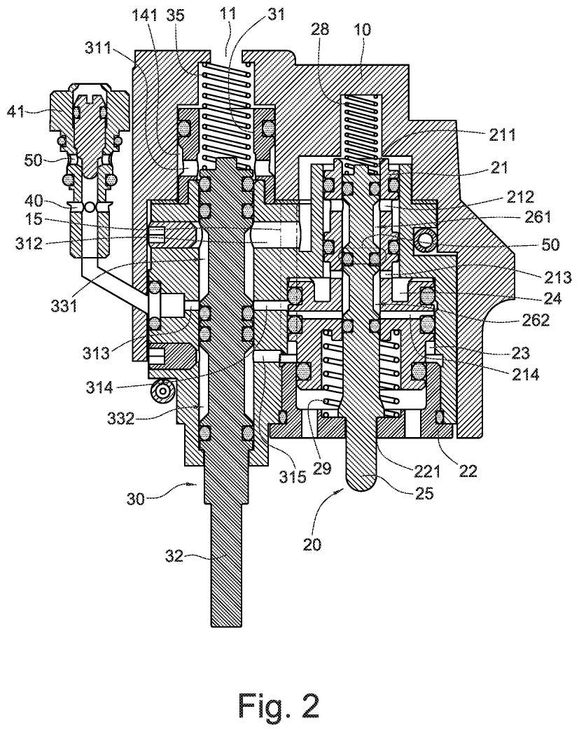

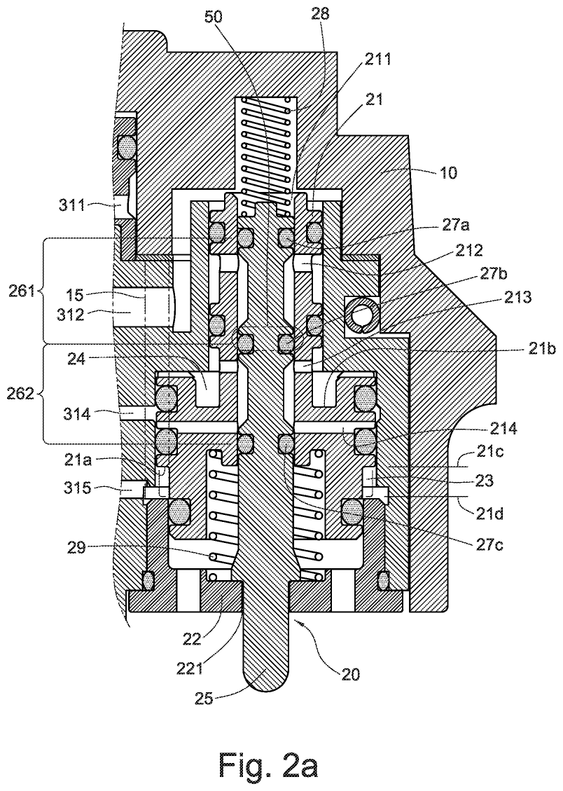

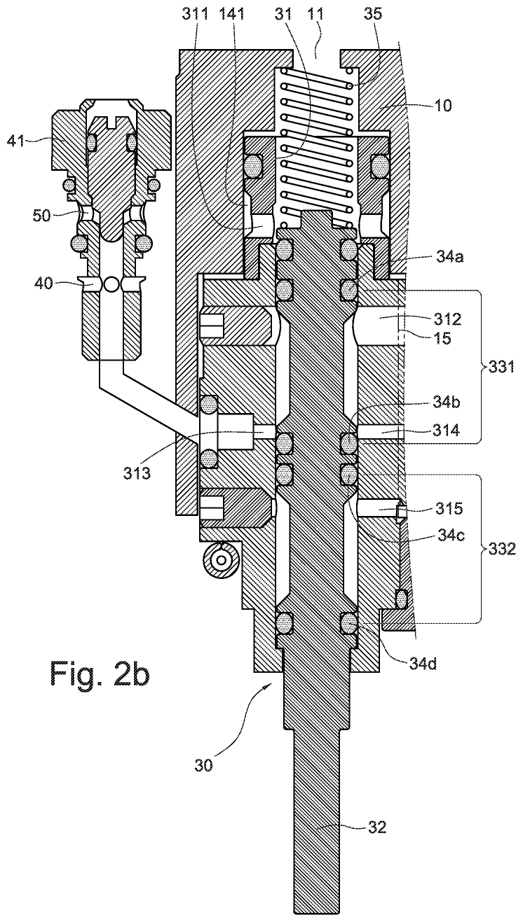

Referring collectively to FIG. 1 and FIG. 2, the detailed construction of a preferred embodiment of the present invention is illustrated. According to the present invention, the air-path structure of the pneumatic nail gun comprises a gun body 10, a trigger valve 20 and a slider valve 30. Specifically:

The inside of the gun body 10 is configured with a cylinder 12, the inside of the cylinder 12 is slidably fitted with a nailing piston 13. The nailing piston 13 divides the inner space of the cylinder 12 into a top-layer cylinder chamber 121 and a bottom-layer cylinder chamber 122 with variable sizes; the top of the cylinder 12 is flexibly configured with a firing valve 14 loaded with a spring. The firing valve 14 does not have to be in a disc shape, and can be rectangular or of any other shape; Specifically, any device used to control the time when the high-pressure air inside the gun body 10 flows into the cylinder 12 (including top-layer cylinder chamber 121 or bottom-layer cylinder chamber 122), and to timely actuate the nailing piston 13 to shoot the nail is defined as firing valve 14 in the present invention. The top of the firing valve 14 is formed with a firing valve air chamber 141. The inside of the gun body 10 is formed with a main air chamber 11 that can contain high-pressure air. The main air chamber 11 encloses the periphery of the cylinder 12 and the filing valve 14. The inside of the gun body 10 is further formed with a time-delayed air chamber 40. The time-delayed air chamber 40 can continuous release high-pressure air into the atmosphere.

Referring collectively to FIG. 2 and FIG. 2a, the trigger valve 20 is configured on the gun body 10. The trigger valve 20 comprises a shuttle valve ring 21, a trigger valve seat 22 and a trigger valve stem 25. Specifically, the trigger valve seat 22 is located on the bottom of the trigger valve 20, and is fixed on the gun body 10. The bottom of the trigger valve seat 22 is formed with a through hole 221. One end of the trigger valve stem 25 goes through the through hole 221 of the trigger valve seat 22 and is exposed out of the gun body 10, so that it can be pressed by the user's finger or the pressing bar of an automatic tool. The trigger valve stem 25 goes through the shuttle valve ring 21. The two ends of the shuttle valve ring 21 are respectively exposed inside a safety-on air chamber 23 and a safety-off air chamber 24. The safety-on air chamber 23 is formed between the shuttle valve ring 21 and the trigger valve seat 22. The safety-off air chamber 24 is formed between the gun body 10 and the shuttle valve ring 21. In implementation, the shuttle valve ring 21 is driven to move by the high-pressure air inside the safety-on air chamber 23 and the safety-off air chamber 24 along the axial direction of the trigger valve stem 25, so that the shuttle valve ring 21 can control the high-pressure air inside the firing valve air chamber 141 to be discharged into the atmosphere 50. The inside of the gun body 10 is formed with an inlet flow channel 15. Both ends of the inlet flow channel 15 are respectively extended to the main air chamber 11 and the safety-on air chamber 23, so that the high-pressure air inside the main air chamber 11 is constantly introduced into the safety-on air chamber 23 via the inlet flow channel 15, so that the safety-on air chamber 23 constantly contains high-pressure air. In addition, the other end of the trigger valve stem 25 is configured with a spring 28. Through the spring load of the spring 28, the trigger valve stem 25 can return to the original position when the user's finger or the pressing bar of an automatic tool stops pressing.

Further, the shuttle valve ring 21 has a first end face 21a and a second end face 21b. Specifically, the first end face 21a is exposed inside the safety-on air chamber 23, and the second end face 21b is exposed inside the safety-off air chamber 24. The first end face 21a of the shuttle valve ring 21 can be pushed by the high-pressure air inside the safety-on air chamber 23 to move along the axial direction of the trigger valve stem 25 to the safety-on position 21c. Alternatively, the second end face 21b of the shuttle valve ring 21 can be pushed by the high-pressure air inside the safety-off air chamber 24 to move along the axial direction of the trigger valve stem 25 to the safety-off position 21d.

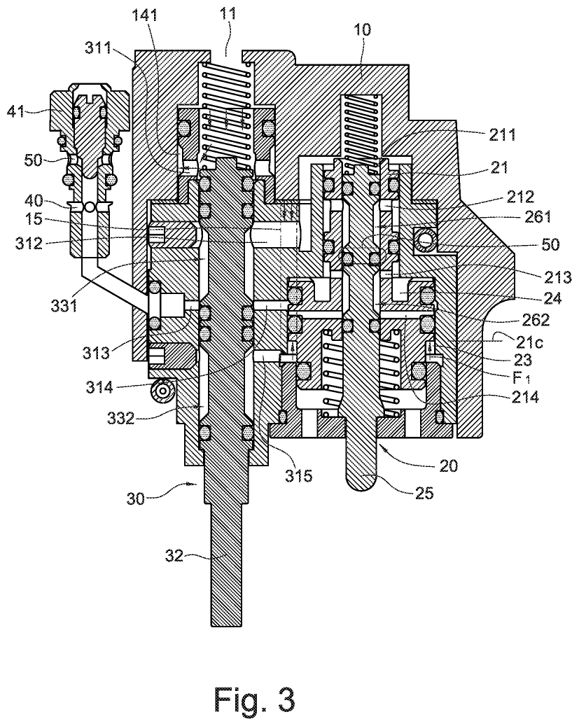

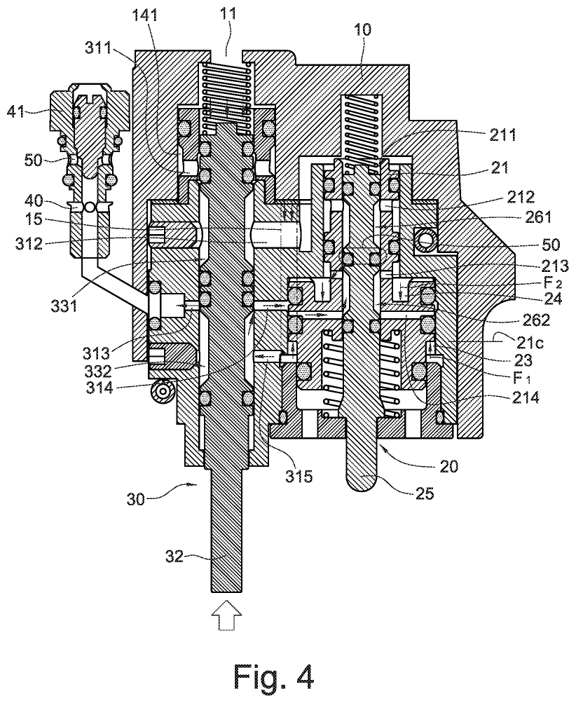

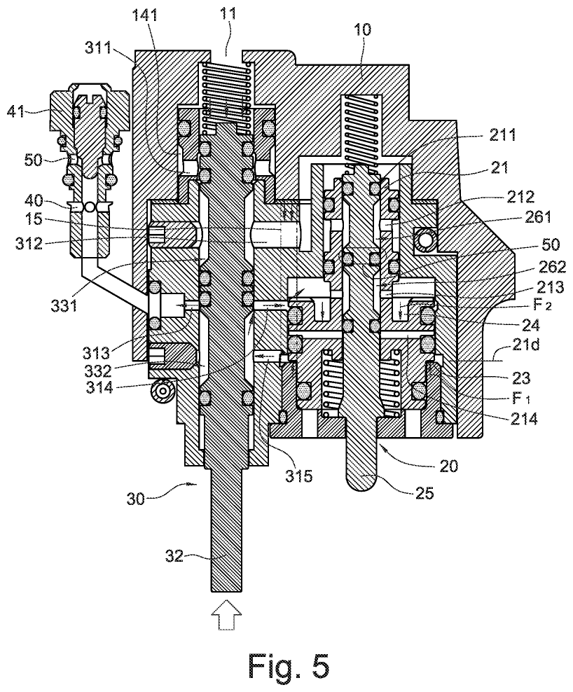

In actual implementation, the high-pressure air inside the safety-on air chamber 23 forms a first thrust F1 (as shown in FIG. 3), and the high-pressure air inside the safety-off air chamber 24 forms a second thrust F2 (as shown in FIG. 4). The first thrust F1 and the second thrust F2 respectively act on the shuttle valve ring 21. The second thrust F2 is opposite the first thrust F1 in direction. Specifically, the first thrust F1 acts on the first end face 21a, and the second thrust F2 acts on the second end face 21b. The thrust of the high-pressure air received by the first end face 21a is relatively less stronger than the thrust received by the second end face 21b. That is to say, when the first end face 21a and the second end face 21b simultaneously contact high-pressure air of the same pressure, the first thrust F1 endured by the first end face 21a (collectively referring to FIG. 5 and FIG. 2a) is relatively less stronger than the second thrust F2 endured by the second end face 21b (i.e., F1<F2). Because the main air chamber 11 and the safety-on air chamber 23 are constantly communicated to each other, the safety-on air chamber 23 and the main air chamber 11 constantly contain the same high-pressure air having the same strength of thrust. Therefore, when the high-pressure air inside the safety-off air chamber 24 is discharged into the atmosphere 50, the first thrust F1 received by the first end face 21a of the shuttle valve ring 21 is relatively stronger than the second thrust F2 received by the second end face 21b (i.e., F1>F2), so that the shuttle valve ring 21 is pushed by the first thrust F1 to move along the axial direction of the trigger valve stem 25 to the safety-on position 21c (as shown in FIG. 3). Consequently, the trigger valve 20 closes the air flow path for the high-pressure air inside the firing valve air chamber 141 to be discharged out of the gun body 10. On the contrary, when high-pressure air is introduced into the safety-off air chamber 24, and the high-pressure air inside the safety-on air chamber 23 goes through the slider valve 30 to the time-delayed air chamber 40 and is continuously discharged into the atmosphere, the first thrust F1 received by the first end face 21a (collectively referring to FIG. 5 and FIG. 2a) is relatively less stronger than the second thrust F2 received by the second end face 21b (i.e., F1<F2), so that the shuttle valve ring 21 is pushed by the second thrust F2 to move along the axial direction of the trigger valve stem 25 to the safety-off position 21d (as shown in FIG. 5). Consequently, the trigger valve 20 opens the air flow path for the high-pressure air inside the firing valve air chamber 141 to be discharged out of the gun body 10. In other words, based on the strength of the second thrust F2 formed by the high-pressure air inside the safety-off air chamber 24, the shuttle valve ring 21 can be driven to move to the safety-on position 21c or the safety-off position 21d. In addition, between the shuttle valve ring 21 and the trigger valve seat 22, a spring 29 is configured. When the first thrust F1 received by the shuttle valve ring 21 is relatively stronger than the second thrust F2 (i.e., F1>F2), through the spring load of the spring 29, it is ensured that the shuttle valve ring 21 is maintained at the safety-on position 21c.

Referring collectively to FIG. 2 and FIG. 2b, the slider valve 30 is configured on the gun body 10. The slider valve 30 comprises a slider valve chamber 31 and a safety slider 32. Specifically, the slider valve chamber 31 is formed inside the gun body 10, and the safety slider 32 is slidably fitted inside the slider valve chamber 31. One end of the safety slider 32 is extended out of the gun body 10, and the other end of the safety slider 32 is planted into the main air chamber 11. The slider valve 30 can control the high-pressure air inside the main air chamber 11 to flow to the firing valve air chamber 141, the time-delayed air chamber 40, and the safety-off air chamber 24, and can control the high-pressure air inside the safety-on air chamber 23 and the safety-off air chamber 24 to respectively flow to the time-delayed air chamber 40. The gun body 10 is configured with a relief valve 41 that is communicated with the time-delayed air chamber 40. The high-pressure air inside the time-delayed air chamber 40 can go through the relief valve 41 and be continuously discharged into the atmosphere. In addition, the other end of the safety slider 32 is configured with a spring 35. Through the spring load of the spring 35, the safety slider 32 can be reset when it is not in contact with the workpiece to be nailed.

Referring again to FIG. 2 and FIG. 2a, between the shuttle valve ring 21 and the trigger valve stem 25, a first valve portion of the trigger valve 261 and a second valve portion of the trigger valve 262 are formed. The ring wall of the shuttle valve ring 21 is formed with a the first perforation 211 communicated with the slider valve 30, a second perforation 212 communicated with the atmosphere 50, a third perforation 213 communicated with the slider valve 30, and a fourth perforation 214 communicated with the slider valve 30. In implementation, the first perforation 211, the second perforation 212, the third perforation 213, and the fourth perforation 214 are respectively formed on the ring wall of the shuttle valve ring 21 sequentially along the axial direction of the shuttle valve ring 21. The valve portion referred to in the present invention means the air flow path formed between different components.

Further, between the inner wall of the shuttle valve ring 21 and the stem wall of the trigger valve stem 25, three sealing gaskets 27a, 27b, 27c can be configured co-axially at intervals along the axial direction. Specifically, between the four components of the inner wall of the shuttle valve ring 21, the stem wall of the trigger valve stem 25, the sealing gasket 27a, and the sealing gasket 27b, the first valve portion of the trigger valve 261 is formed. Between the four components of the inner wall of the shuttle valve ring 21, the stem wall of the trigger valve stem 25, the sealing gasket 27b, and the sealing gasket 27c, the second valve portion of the trigger valve 262 is formed. The first valve portion of the trigger valve 261 can control the time of communication between the first perforation 211 and the second perforation 212, whereas the second valve portion of the trigger valve 262 can control the time of communication between the third perforation 213 and the fourth perforation 214.

Referring again to FIG. 2 and FIG. 2b, between the slider valve chamber 31 and the safety slider 32, a first valve portion of the slider valve 331 and a second valve portion of the slider valve 332 are respectively formed. The wall of the slider valve chamber 31 is formed with a first flow channel 311 communicated to the firing valve air chamber 141, a second flow channel 312 communicated with the trigger valve 20, a third flow channel 313 communicated with the time-delayed air chamber 40, a fourth flow channel 314 communicated with trigger valve 20, and a fifth flow channel 315 communicated with the main air chamber 11. In implementation, the fifth flow channel 315 is extended to the inlet flow channel 15 and is communicated with the main air chamber 11. In addition, the second flow channel 312 and the fourth flow channel 314 are not communicated with the inlet flow channel 15.

Further, between the wall of the slider valve chamber 31 and the stem wall of the safety slider 32, four sealing gaskets 34a, 34b, 34c, 34d can be configured at intervals co-axially along the axle. Specifically, between the four components of the wall of the slider valve chamber 31, the stem wall of the safety slider 32, the sealing gasket 34a, and the sealing gasket 34b, the first valve portion of the slider valve 331 is formed. The first valve portion of the slider valve 331 can control the time of communication between the main air chamber 11 and the first flow channel 311, and control the time of communication between the second flow channel 312, the third flow channel 313, and the fourth flow channel 314. The first valve portion of the slider valve 331 can also control the time of communication between the first flow channel 311 and the second flow channel 312. In other words, through control of the first valve portion of the slider valve 331, the main air chamber 11 and the first flow channel 311 can be communicated with each other, and the second flow channel 312, the third flow channel 313, and the fourth flow channel 314 can be communicated with each other, or, the first flow channel 311 and the second flow channel 312 can be communicated with each other. Between the four components of the wall of the slider valve chamber 31, the stem wall of the safety slider 32, the sealing gasket 34c, and the sealing gasket 34d, the second valve portion of the slider valve 332 is formed. The time of communication between the third flow channel 313 and the fourth flow channel 314 is controlled by the second valve portion of the slider valve 332. In other words, through the control of the second valve portion of the slider valve 332, the third flow channel 313 and the fourth flow channel 314 can be communicated with each other.

Sequentially referring to FIG. 3 to FIG. 8, the firstly, when the pneumatic nail gun is in the initial state (as shown in FIG. 3), that is to say, when the user has not pressed the trigger valve stem 25 and pushed the safety slider 32 on the pneumatic nail gun, the high-pressure air inside the main air chamber 11 will go through the inlet flow channel 15 into the safety-on air chamber 23 to constantly increase pressure, and as the high-pressure air inside the safety-off air chamber 24 has already been discharged, the first thrust F1 is stronger than the second thrust F2 (i.e., F1>F2), so that the shuttle valve ring 21 is pushed by the first thrust F1 to the safety-on position 21c. Consequently, the first valve portion of the trigger valve 261 will close the path from the first perforation 211 to the second perforation 212, so that the high-pressure air inside the firing valve air chamber 141 cannot go through the trigger valve 20 and be discharged into the atmosphere 50. At the same time, the high-pressure air inside the main air chamber 11 goes through the first flow channel 311 into the firing valve air chamber 141.

Then, when the user presses the safety slider 32 (as shown in FIG. 4), the first valve portion of the slider valve 331 closes the path from the main air chamber 11 to the first flow channel 311 and opens the path from the first flow channel 311 to the second flow channel 312, so that the high-pressure air inside the main air chamber 22 cannot go into the firing valve air chamber 141. At the same time, the second valve portion of the slider valve 332 opens the path between the third flow channel 313, the fourth flow channel 314, and the fifth flow channel 315, so that the high-pressure air inside the main air chamber 11 not only goes through the inlet flow channel 15 into the safety-on air chamber 23, but also goes through the fifth flow channel 315, the second valve portion of the slider valve 332, the fourth flow channel 314, the fourth perforation 214, the second valve portion of the trigger valve 262, and the third perforation 213 into the safety-off air chamber 24, and the high-pressure air inside the safety-on air chamber 23 goes through the fifth flow channel 315, the second valve portion of the slider valve 332, and the third flow channel 313 into the time-delayed air chamber 40. Because the time-delayed air chamber 40 continuously discharges high-pressure air into the atmosphere through the relief valve 41, the first thrust F1 is less stronger than the second thrust F2 (i.e., F1<F2), so that the shuttle valve ring 21 is pushed by the second thrust F2 to the safety-off position 21d (See FIG. 5). After the shuttle valve ring 21 is moved to the safety-off position 21d, the high-pressure air that originally goes from the main air chamber 11 through the fifth flow channel 315, the second valve portion of the slider valve 332, the fourth flow channel 314, the fourth perforation 214, the second valve portion of the trigger valve 262, and the third perforation 213 into the safety-off air chamber 24 will go directly through the fifth flow channel 315, the second valve portion of the slider valve 332, and the fourth flow channel 314 into the safety-off air chamber 24.

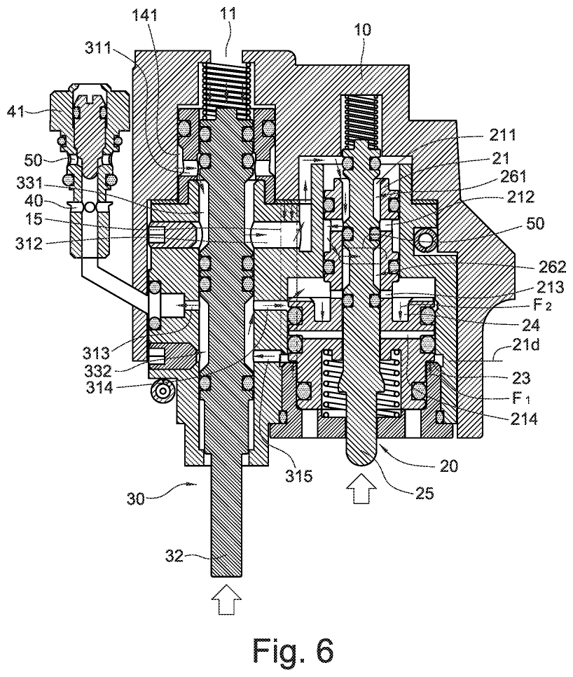

Then, when the user presses and holds the safety slider 32, and then presses the trigger valve stem 25 (as shown in FIG. 6), the first valve portion of the trigger valve 261 opens the path from the first perforation 211 to the second perforation 212, so that the high-pressure air inside the firing valve air chamber 141 will go through the first flow channel 311, the first valve portion of the slider valve 331, the second flow channel 312, the first perforation 211, the first valve portion of the trigger valve 261, and the air flow path formed by the second perforation 212, and be discharged into the atmosphere 50. As a result, the pressure inside the firing valve air chamber 141 will decrease, and the firing valve 14 will move to let the high-pressure air inside the main air chamber 11 into the top-layer cylinder chamber 121, thus driving the nailing piston 13 to shoot the nail.

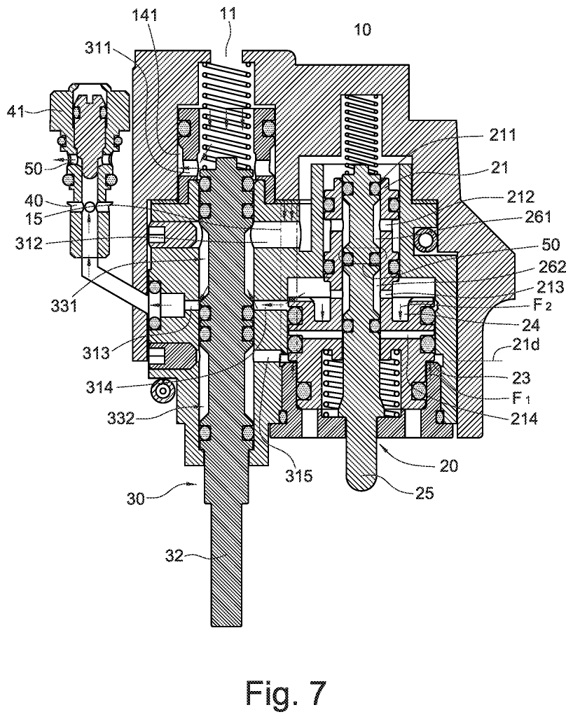

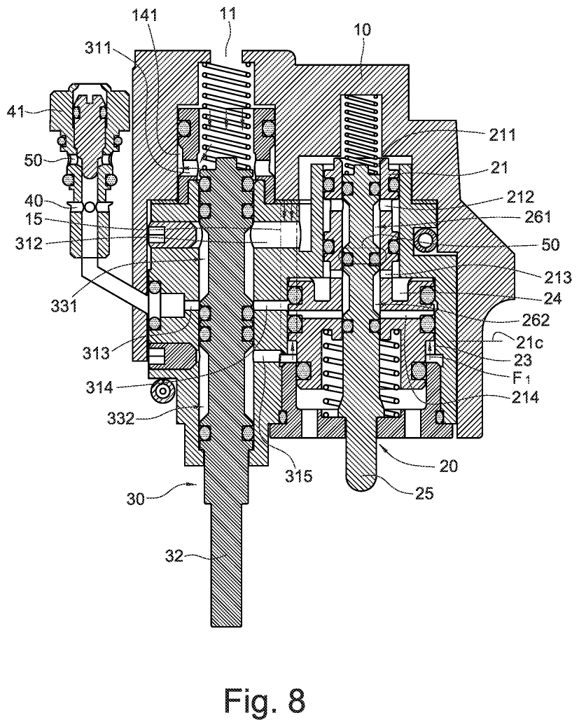

When the user firstly presses and holds the safety slider 32 and then presses the trigger valve stem 25 for the pneumatic nail gun to shoot a nail, if the user releases the trigger valve stem 25 and the safety slider 32 (as shown in FIG. 7) for the first valve portion of the trigger valve 261 to close the path from the first perforation 211 to the second perforation 212, and for the first valve portion of the slider valve 331 to close the path from the first flow channel 311 to the second flow channel 312, the high-pressure air inside the firing valve air chamber 141 cannot go through the trigger valve 20 and be discharged into the atmosphere 50; at the same time, the first valve portion of the slider valve 331 will open the path from the main air chamber 11 to the first flow channel 311, so that the high-pressure air inside the main air chamber 11 will go through the first flow channel 311 into the firing valve air chamber 141, and the first valve portion of the slider valve 331 will also open the path between the second flow channel 312, the third flow channel 313, and the fourth flow channel 314, so that the high-pressure air inside the safety-off air chamber 24 will go through the fourth flow channel 314, the first valve portion of the slider valve 331, and the third flow channel 313 into the time-delayed air chamber. Because the time-delayed air chamber 40 continuously releases high-pressure air into the atmosphere via the relief valve 41, and the second valve portion of the slider valve 332 closes the path between the third flow channel 313, the fourth flow channel 314, and the fifth flow channel 315, the high-pressure air inside the safety-on air chamber 23 cannot go into the time-delayed air chamber 40, so that the first thrust F1 is stronger than the second thrust F2 (i.e., F1>F2), and the shuttle valve ring 21 is pushed by the first thrust F1 to the safety-on position 21c (as shown in FIG. 8).

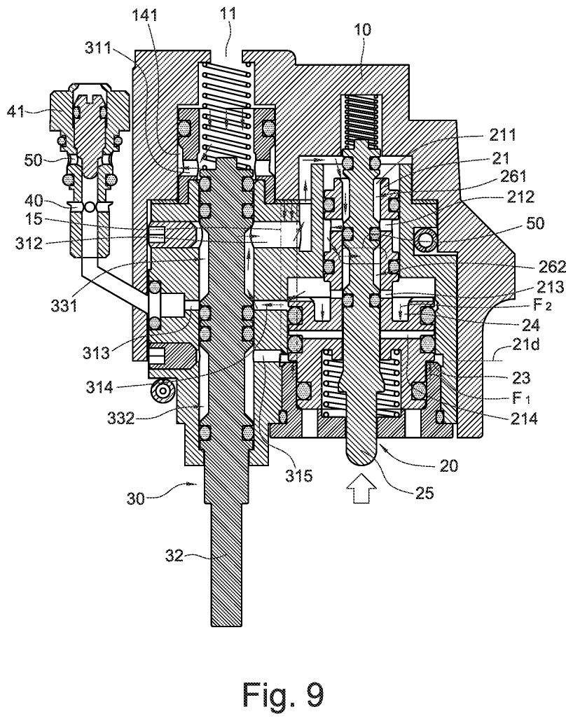

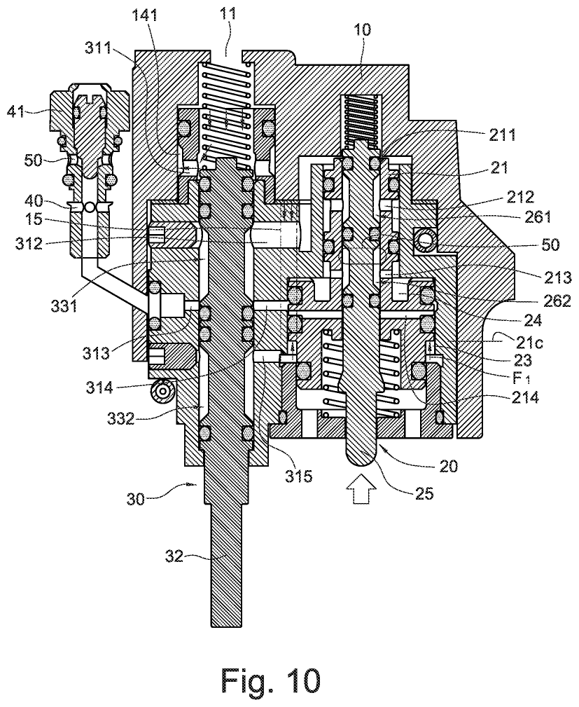

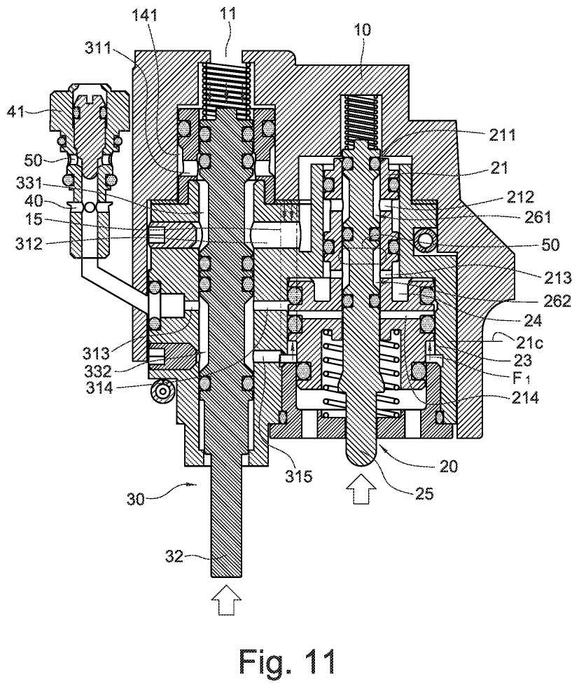

Sequentially referring to FIG. 9 to FIG. 11, when the user firstly presses and holds the safety slider 32 and then presses the trigger valve stem 25 for the pneumatic nail gun to shoot a nail, if the user presses and holds the trigger valve stem 25 and releases the safety slider 32 (as shown in FIG. 9) for the first valve portion of the slider valve 331 to close the path from the first flow channel 311 to the second flow channel 312, the high-pressure air inside the firing valve air chamber 141 cannot go through the trigger valve 20 to be discharged into the atmosphere 50. At the same time, the first valve portion of the slider valve 331 will open the path from the main air chamber 11 to the first flow channel 311, so that the high-pressure air inside the main air chamber 11 can go through the first flow channel 311 into the firing valve air chamber 141. The first valve portion of the slider valve 331 will also open the path between the second flow channel 312, the third flow channel 313, and the fourth flow channel 314, so that the high-pressure air inside the safety-off air chamber 24 can go through the air flow path formed by the fourth flow channel 314, the first valve portion of the slider valve 331, the second flow channel 312, the first perforation 211, the first valve portion of the trigger valve 261, and the second perforation 212, and be discharged into the atmosphere 50. The second valve portion of the slider valve 332 will close the path between the third flow channel 313, the fourth flow channel 314, and the fifth flow channel 315, so that the high-pressure air inside the safety-on air chamber 23 cannot go into the time-delayed air chamber 40, and the first thrust F1 is stronger than the second thrust F2 (i.e., F1>F2). As a result, the shuttle valve ring 21 is pushed by the first thrust F1 to the safety-on position 21c (as shown in FIG. 10). Then, when the user presses and holds the trigger valve stem 25 and then presses the safety slider 32 (as shown in FIG. 11), because the shuttle valve ring 21 moves to the safety-on position 21c, the first valve portion of the trigger valve 261 will close the path from the first perforation 211 to the second perforation 212, so that the high-pressure air inside the firing valve air chamber 141 cannot go through the trigger valve 20 and be discharged into the atmosphere 50, and therefore cannot actuate the nailing.

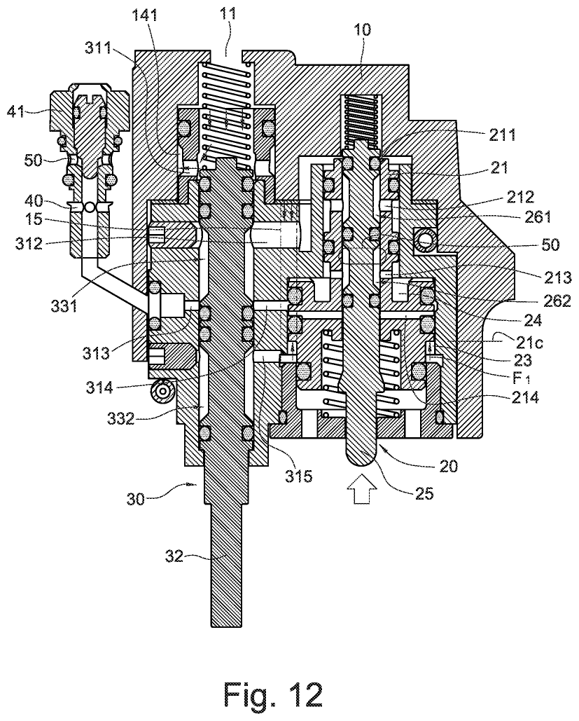

Sequentially referring to FIG. 12 to FIG. 17, when the pneumatic nail gun is in the initial state, and the trigger valve stem 25 is pressed (as shown in FIG. 12), because the second valve portion of the slider valve 332 closes the path between the third flow channel 313, the fourth flow channel 314, and the fifth flow channel 315, the high-pressure air going from the main air chamber 11 into the safety-on air chamber 23 via the inlet flow channel 15 cannot go into the time-delayed air chamber 40, and the high-pressure air inside the safety-off air chamber 24 has already been discharged, thus the first thrust F1 is stronger than the second thrust F2 (i.e., F1>F2), and the shuttle valve ring 21 is maintained at the safety-on position 21c.

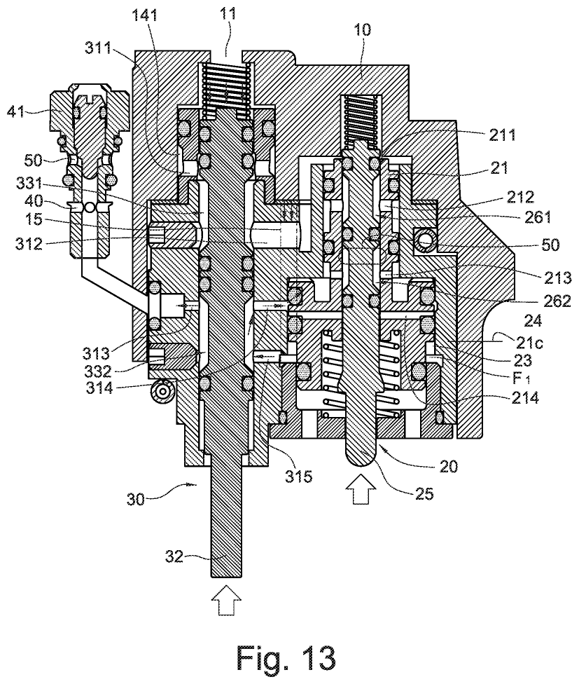

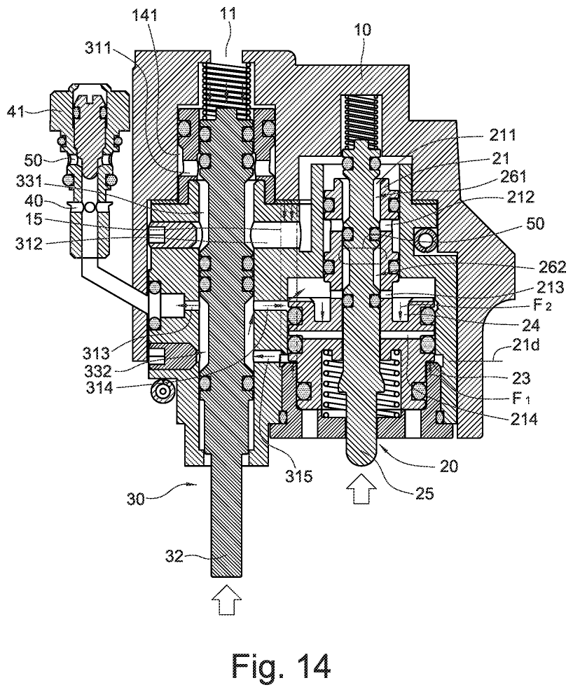

Then, when the user presses and holds the trigger valve stem 25 and then presses the safety slider 32 (as shown in FIG. 13), because the second valve portion of the slider valve 332 opens the path between the third flow channel 313, the fourth flow channel 314, and the fifth flow channel 315, the high-pressure air inside the main air chamber 11 not only goes through the inlet flow channel 15 into the safety-on air chamber 23, but also goes through the fifth flow channel 315, the second valve portion of the slider valve 332, the fourth flow channel 314, the fourth perforation 214, the second valve portion of the trigger valve 262, the third perforation 213 into the safety-off air chamber 24, and the high-pressure air inside the safety-on air chamber 23 goes through the fifth flow channel 315, the second valve portion of the slider valve 332, and the third flow channel 313 into the time-delayed air chamber 40. Because the time-delayed air chamber 40 continuously releases high-pressure air into the atmosphere via the relief valve 41, the first thrust F1 is less stronger than the second thrust F2 (i.e., F1<F2), and the shuttle valve ring 21 is pushed by the second thrust F2 to the safety-off position 21d (as shown in FIG. 14).

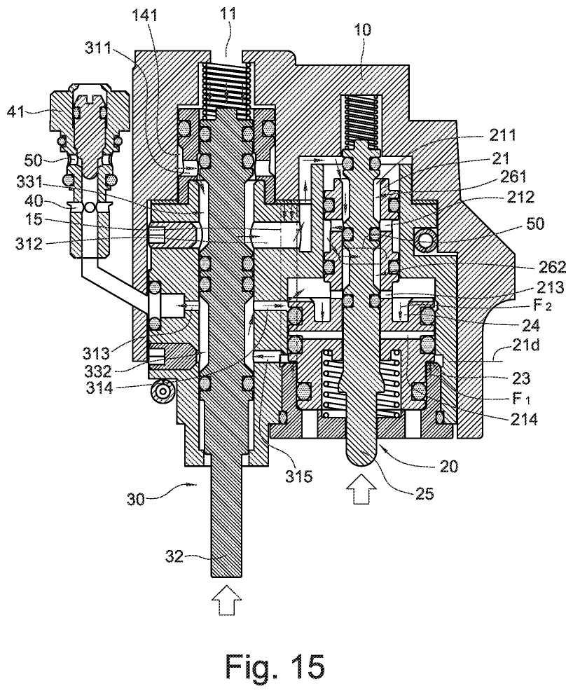

Then, after the shuttle valve ring 21 is moved to the safety-off position 21d, the high-pressure air originally going from the main air chamber 11 to the safety-off air chamber 24 via the fifth flow channel 315, the second valve portion of the slider valve 332, the fourth flow channel 314, the fourth perforation 214, the second valve portion of the trigger valve 262, and the third perforation 213 will go directly through the fifth flow channel 315, the second valve portion of the slider valve 332, and the fourth flow channel 314 into the safety-off air chamber 24. Meanwhile, the first valve portion of the trigger valve 261 will open the path from the first perforation 211 to the second perforation 212, so that the high-pressure air inside the firing valve air chamber 141 can go through the air flow path formed by the first flow channel 311, the first valve portion of the slider valve 331, the second flow channel 312, the first perforation 211, the first valve portion of the trigger valve 261, and the second perforation 212, and be discharged into the atmosphere 50 (as shown in FIG. 15). As a result, the pressure inside the firing valve air chamber 141 will decrease to cause a displacement of the firing valve 14, allowing the high-pressure air inside the main air chamber 11 to flow into the top-layer cylinder chamber 121, thus driving the nailing piston 13 to shoot the nail.

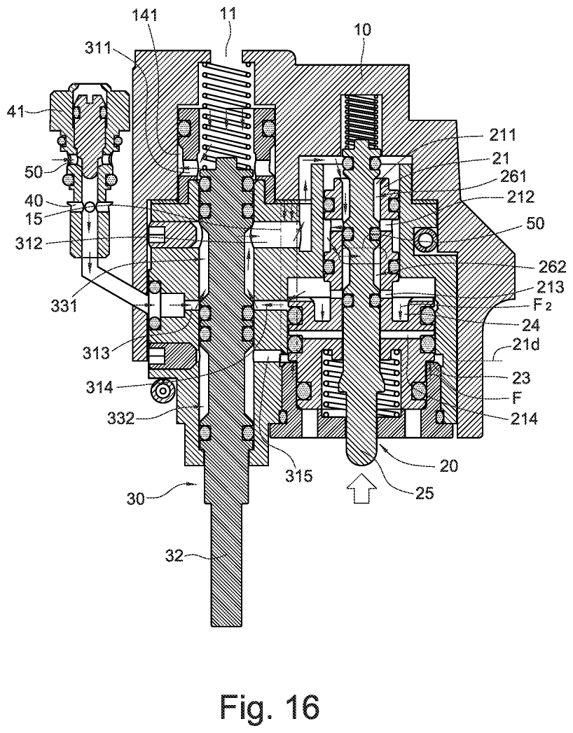

After the user firstly presses and holds the trigger valve stem 25, and then presses the safety slider 32 for the pneumatic nail gun to shoot a nail, if the user presses and holds the trigger valve stem 25 and releases the safety slider 32 (as shown in FIG. 16) for the first valve portion of the slider valve 331 to close the path from the first flow channel 311 to the second flow channel 312, the high-pressure air inside the firing valve air chamber 141 cannot go through the trigger valve 20 to be discharged into the atmosphere 50. At the same time, the first valve portion of the slider valve 331 will open the path from the main air chamber 11 to the first flow channel 311, so that the high-pressure air inside the main air chamber 11 can go through the first flow channel 311 into the firing valve air chamber 141. The first valve portion of the slider valve 331 also opens the path between the second flow channel 312, the third flow channel 313, and the fourth flow channel 314, so that the high-pressure air inside the safety-off air chamber 24 goes through the air flow path formed by the fourth flow channel 314, the first valve portion of the slider valve 331, the second flow channel 312, the first perforation 211, the first valve portion of the trigger valve 261, and the second perforation 212 to be discharged into the atmosphere 50. Meanwhile, the high-pressure air inside the time-delayed air chamber 40 goes through the air flow path formed by the third flow channel 313, the first valve portion of the slider valve 331, the second flow channel 312, the first perforation 211, the first valve portion of the trigger valve 261, and the second perforation 212 to be discharged into the atmosphere 50. Also, the second valve portion of the slider valve 332 closes the path between the third flow channel 313, the fourth flow channel 314, and the fifth flow channel 315, so that the high-pressure air inside the safety-on air chamber 23 cannot go into the time-delayed air chamber 40. As a result, the first thrust F1 is stronger than the second thrust F2 (i.e., F1>F2), and the shuttle valve ring 21 will be pushed by the first thrust F1 to the safety-on position 21c after a specific period of time.

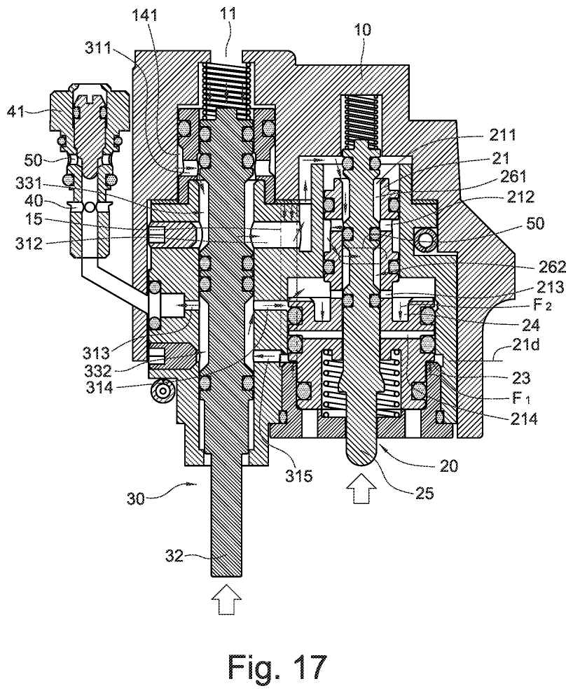

If the user presses the safety slider 32 again after a specific period of time (as shown in FIG. 17), the first valve portion of the slider valve 331 will open the path from the first flow channel 311 to the second flow channel 312. Because the shuttle valve ring 21 is not pushed by the first thrust F1 to the safety-on position 21c, the high-pressure air inside the firing valve air chamber 141 can go through the air flow path formed by the first flow channel 311, the first valve portion of the slider valve 331, the second flow channel 312, the first perforation 211, the first valve portion of the trigger valve 261, and the second perforation 212 to be discharged into the atmosphere 50. As a result, the pressure inside the firing valve air chamber 141 will decrease to cause a displacement of the firing valve 14, which allows the high-pressure air inside the main air chamber 11 to flow into the top-layer cylinder chamber 121, thus driving the nailing piston 13 to shoot the nail. At the same time, the second valve portion of the slider valve 332 opens the path between the third flow channel 313, the fourth flow channel 314, and the fifth flow channel 315, so that the high-pressure air inside the main air chamber 11 not only goes through the inlet flow channel 15 into the safety-on air chamber 23, but also goes through the fifth flow channel 315, the second valve portion of the slider valve 332, the fourth flow channel 314, the fourth perforation 214, the second valve portion of the trigger valve 262, and the third perforation 213 into the safety-off air chamber 24. Meanwhile, the high-pressure air inside the safety-on air chamber 23 goes through the fifth flow channel 315, the second valve portion of the slider valve 332, and the third flow channel 313 into the time-delayed air chamber 40. Because the time-delayed air chamber 40 continuously releases high-pressure air into the atmosphere via the relief valve 41, the first thrust F1 is less stronger than the second thrust F2 (i.e., F1<F2), and the shuttle valve ring 21 is maintained at the safety-off position 21d.

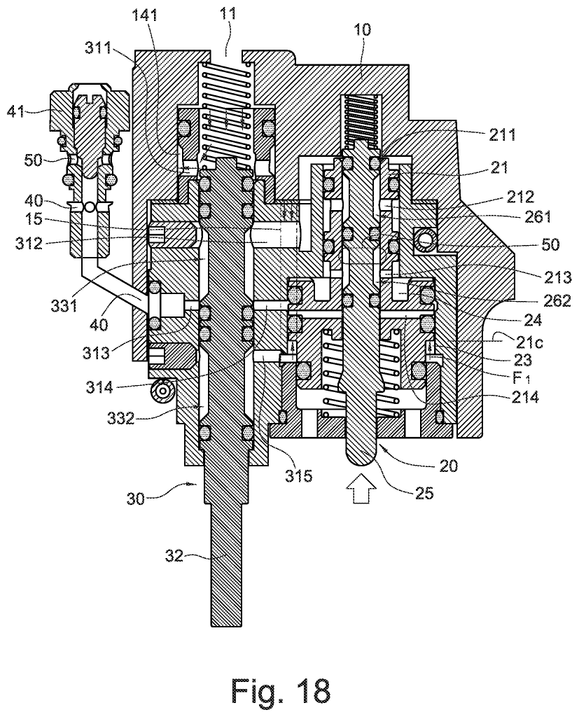

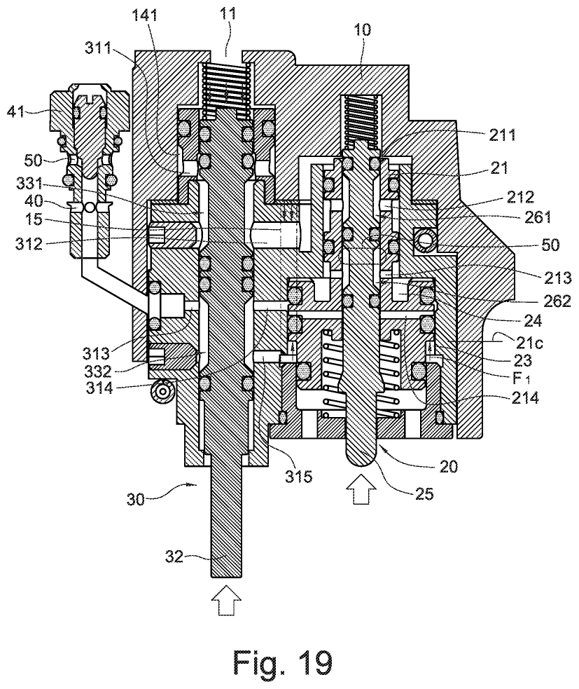

If the user has not pressed the safety slider 32 within a specified period of time (as shown in FIG. 18), the shuttle valve ring 21 will be pushed by the first thrust F1 to the safety-on position 21c. If the user presses the safety slider 32 only after a specific period of time (as shown in FIG. 19), because the shuttle valve ring 21 is pushed by the first thrust F1 to the safety-on position 21c, the first valve portion of the trigger valve 261 closes the path from the first perforation 211 to the second perforation 212, so that the high-pressure air inside the firing valve air chamber 141 cannot go through the trigger valve 20 to be discharged into the atmosphere 50, and therefore the pneumatic nail gun cannot shoot the nail.

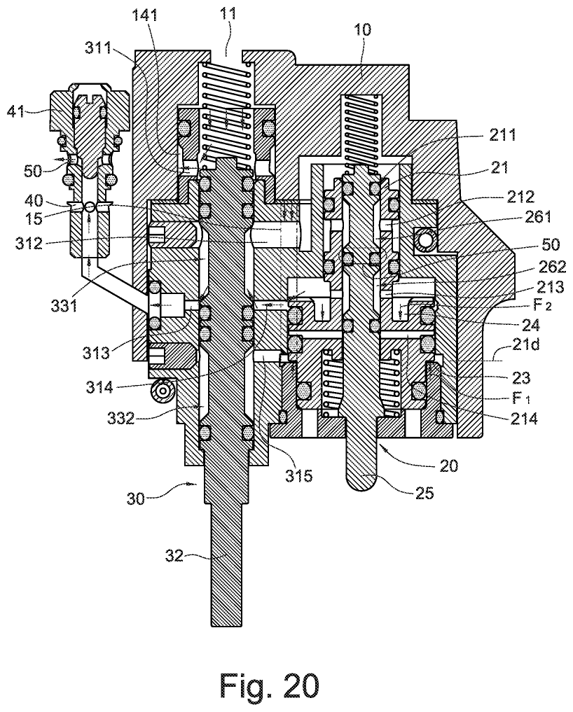

When the user firstly presses and holds the trigger valve stem 25 and then presses the safety slider 32 for the pneumatic nail gun to shoot a nail, if the user releases the trigger valve stem 25 and safety slider 32 (as shown in FIG. 20), the first valve portion of the trigger valve 261 closes the path from the first perforation 211 to the second perforation 212, and the first valve portion of the slider valve 331 closes the path from the first flow channel 311 to the second flow channel 312, so that the high-pressure air inside the firing valve air chamber 141 cannot go through the trigger valve 20 be discharged into the atmosphere 50. At the same time, the first valve portion of the slider valve 331 opens the path from the main air chamber 11 to the first flow channel 311, so that the high-pressure air inside the main air chamber 11 can go through the first flow channel 311 into the firing valve air chamber 141. The first valve portion of the slider valve 331 also opens the path between the second flow channel 312, the third flow channel 313, and the fourth flow channel 314, so that the high-pressure air inside the safety-off air chamber 24 goes through the fourth flow channel 314, the first valve portion of the slider valve 331, and the third flow channel 313 into the time-delayed air chamber. Because the time-delayed air chamber 40 continuously releases high-pressure air into the atmosphere via the relief valve 41, and the second valve portion of the slider valve 332 closes the path between the third flow channel 313, the fourth flow channel 314, and the fifth flow channel 315, the high-pressure air inside the safety-on air chamber 23 cannot go into the time-delayed air chamber 40. Thus, the first thrust F1 is stronger than the second thrust F2 (i.e., F1>F2), and the shuttle valve ring 21 will be pushed by the first thrust F1 to the safety-on position 21c after a specific period of time. If the user presses and holds the trigger valve stem 25 within a specific period of time and then presses the safety slider 32, because the shuttle valve ring 21 is still at the safety-off position 21d, the high-pressure air inside the firing valve air chamber 141 can go through the air flow path formed by the first flow channel 311, the first valve portion of the slider valve 331, the second flow channel 312, the first perforation 211, the first valve portion of the trigger valve 261, and the second perforation 212 to be discharged into the atmosphere 50, so that the pneumatic nail gun can shoot a nail. On the contrary, if the user presses and holds the trigger valve stem 25 and then presses the safety slider 32 after a specific period of time, because the shuttle valve ring 21 is already pushed by the first thrust F1 to the safety-on position 21c, the first valve portion of the trigger valve 261 closes the path from the first perforation 211 to the second perforation 212, so that the high-pressure air inside the firing valve air chamber 141 cannot be discharged into the atmosphere 50 via the trigger valve 20, and therefore the pneumatic nail gun cannot shoot the nail.

Although the invention has been explained in relation to its preferred embodiment, it is to be understood that many other possible modifications and variations can be made without departing from the spirit and scope of the invention as hereinafter claimed.

1. An air-path structure of pneumatic nail gun, comprising:
a gun body, having a main air chamber containing high-pressure air, a firing valve air chamber and a time-delayed air chamber that continuously releases the high-pressure air into the atmosphere;
a trigger valve, configured on the gun body, the trigger valve comprises a shuttle valve ring, a safety-on air chamber and a safety-off air chamber, both ends of the shuttle valve ring are respectively exposed inside the safety-on air chamber and the safety-off air chamber, the high-pressure air inside the safety-on air chamber forms a first thrust, the high-pressure air inside the safety-off air chamber forms a second thrust, the first thrust and the second thrust respectively act on the shuttle valve ring, the second thrust is opposite the first thrust in direction, through the shuttle valve ring, the trigger valve controls the high-pressure air inside the firing valve air chamber to be discharged out of the gun body;
a slider valve, configured on the gun body, the slider valve controls the high-pressure air inside the main air chamber flowing toward the firing valve air chamber, the time-delayed air chamber and the safety-off air chamber, and controls the high-pressure air inside the safety-on air chamber and the safety-off air chamber respectively flowing toward the time-delayed air chamber;
specifically, the safety-on air chamber is constantly communicated with the main air chamber and constantly contains high-pressure air, and the high-pressure air inside the safety-off air chamber flows through the slider valve toward the time-delayed air chamber and is continuously discharged into the atmosphere, so that the first thrust is stronger than the second thrust, thus driving the shuttle valve ring to move to a safety-on position, and consequently the trigger valve will close the air flow path for the high-pressure air inside the firing valve air chamber to be discharged out of the gun body;
the high-pressure air inside the main air chamber flows through the slider valve toward the safety-off air chamber, the high-pressure air inside the safety-on air chamber flows through the slider valve toward the time-delayed air chamber and is continuously discharged into the atmosphere, so that the second thrust is stronger than the first thrust, thus driving the shuttle valve ring to move from the safety-on position to the safety-off position, and consequently the trigger valve will open the air flow path for the high-pressure air inside the firing valve air chamber to be discharged out of the gun body.

2. The air-path structure of pneumatic nail gun defined in claim 1, wherein the inside of the gun body is formed with an inlet flow channel, the two ends of the inlet flow channel respectively extend to the main air chamber and the safety-on air chamber, the high-pressure air inside the main air chamber flows through the inlet flow channel toward the safety-on air chamber.

3. The air-path structure of pneumatic nail gun defined in claim 2, wherein the trigger valve further comprises a trigger valve seat and a trigger valve stem, the trigger valve seat is located on the bottom of the trigger valve and is fixed on the gun body, the trigger valve stem goes through the shuttle valve ring and the trigger valve seat, the safety-on air chamber is formed within the shuttle valve ring and the trigger valve seat, and the safety-off air chamber is formed between the gun body and the shuttle valve ring.

4. The air-path structure of pneumatic nail gun defined in claim 3, wherein said shuttle valve ring has a first end face and a second end face, the first end face is exposed inside the safety-on air chamber, the second end face is exposed inside the safety-off air chamber, the area of the first end face receiving the thrust of the high-pressure air is relatively smaller than that of the second end face.

5. The air-path structure of pneumatic nail gun defined in claim 3, wherein, between the shuttle valve ring and the trigger valve stem, a first valve portion of the trigger valve and a second valve portion of the trigger valve are formed, the ring wall of the shuttle valve ring is formed with a first perforation communicated with the slider valve, a second perforation communicated with the atmosphere, a third perforation communicated with the slider valve, and a fourth perforation communicated with the slider valve, the first valve portion of the trigger valve can control the time of communication between the first perforation and the second perforation, the second valve portion of the trigger valve can control the time of communication between the third perforation and the fourth perforation.

6. The air-path structure of pneumatic nail gun defined in claim 5, wherein, the first valve portion of the trigger valve and the second valve portion of the trigger valve are respectively formed between the shuttle valve ring and the trigger valve stem sequentially along the axial direction of the shuttle valve ring, the first perforation, the second perforation, the third perforation, and the fourth perforation are respectively formed on the ring wall of the shuttle valve ring sequentially along the axial direction of the shuttle valve ring.

7. The air-path structure of pneumatic nail gun defined in claim 1, wherein the inside of the gun body is formed with a slider valve chamber, the slider valve comprises a safety slider fitted inside the slider valve chamber, one end of the safety slider is extended out of the gun body, and the other end of the safety slider is planted into the main air chamber.

8. The air-path structure of pneumatic nail gun defined in claim 7, wherein, between the slider valve chamber and the safety slider, a first valve portion of the slider valve and a second valve portion of the slider valve are respectively formed, the wall of the slider valve chamber is formed with a first flow channel communicated with the firing valve air chamber, a second flow channel communicated with the trigger valve, a third flow channel communicated with the time-delayed air chamber, a fourth flow channel communicated with the trigger valve, and a fifth flow channel communicated with the main air chamber, the first valve portion of the slider valve can control the time of communication between the main air chamber and the first flow channel, and control the time of communication between the second flow channel, the third flow channel and the fourth flow channel, the first valve portion of the slider valve can also control the time of communication between the first flow channel and the second flow channel, the second valve portion of the slider valve can control the time of communication between the third flow channel, the fourth flow channel, and the fifth flow channel.

9. The air-path structure of pneumatic nail gun defined in claim 8, wherein said first valve portion of the slider valve and said the second valve portion of the slider valve are respectively formed between the slider valve chamber and the safety slider sequentially along the axial direction of the slider valve chamber, the first flow channel, the second flow channel, the third flow channel, the fourth flow channel, and the fifth flow channel are respectively formed on the wall of the slider valve chamber sequentially along the axial direction of the slider valve chamber.

10. The air-path structure of pneumatic nail gun defined in claim 1, wherein said gun body is configured with a relief valve communicated with the time-delayed air chamber, the high-pressure air inside the time-delayed air chamber is continuously discharged into the atmosphere via the relief valve.
